(19) United States
(12) Patent Application Publication
(10) Pub. No.: US 2014/0059070 A1
(43) Pub. Date: Feb. 27, 2014

(54) NON-TRANSITORY COMPUTER READABLE MEDIUM, INFORMATION SEARCH APPARATUS, AND INFORMATION SEARCH METHOD

(71) Applicant: FUJI XEROX CO., LTD., Tokyo (JP)

(72) Inventors: Keigo HATTORI, Yokohama-shi (JP); Yasuhide MIURA, Yokohama-shi (JP); Tomoko OKUMA, Yokohama-shi (JP)

(73) Assignee: FUJI XEROX CO., LTD., Tokyo (JP)

(21) Appl. No.: 13/752,746

(22) Filed: Jan. 29, 2013

(30) Foreign Application Priority Data
Aug. 24, 2012 (JP) 2012-184994

(51) Int. Cl. G06F 17/30

(52) U.S. Cl. CPC G06F 17/30637
USPC 707/766

(57) ABSTRACT

A non-transitory computer readable medium stores a program causing a computer to execute a process including accepting input of multiple search keywords; searching streaming data in which multiple pieces of character information about multiple users are managed in time series for the character information including one of the multiple search keywords; acquiring the character information within a predetermined time range with respect to the character information including the one of the multiple search keywords, among the other pieces of character information about the user who has posted the character information including the one of the multiple search keywords, as user data; searching the user data for the character information including the multiple search keywords other than the one search keyword; and outputting the character information within a predetermined time range with respect to the result of the search in the user data as output data.

### CROSS-REFERENCE TO RELATED APPLICATIONS

This application is based on and claims priority under 35 USC 119 from Japanese Patent Application No. 2012-184994 filed Aug. 24, 2012.

### BACKGROUND

1. Technical Field

The present invention relates to a non-transitory computer readable medium, an information search apparatus, and an information search method.

2. Summary

According to an aspect of the invention, there is provided a non-transitory computer readable medium storing a program causing a computer to execute a process including accepting input of multiple search keywords; searching streaming data in which multiple pieces of character information about multiple users are managed in time series for the character information including one of the multiple search keywords that are accepted; acquiring the character information within a predetermined time range with respect to the character information including the one of the multiple search keywords, among the other pieces of character information about the user who has posted the character information that is searched for and that includes the one of the multiple search keywords, as user data; searching the acquired user data for the character information including the multiple search keywords other than the one search keyword; and outputting the character information within a predetermined time range with respect to the result of the search in the user data as output data.

### BRIEF DESCRIPTION OF THE DRAWINGS

Exemplary embodiments of the present invention will be described in detail based on the following figures, wherein:

FIG. 1 is a block diagram illustrating an example of the configuration of an information search apparatus according to a first exemplary embodiment;

FIGS. 2A and 2B are schematic views illustrating an example of a search keyword input user interface that accepts input of search keywords;

FIG. 3 is a schematic view illustrating an example of the structure of streaming data;

FIG. 4 is a schematic view illustrating an example of the structure of user data;

FIG. 5 is a schematic view illustrating an example of the relationship between data range information and the user data;

FIG. 6 is a schematic view for illustrating a keyword search operation in the user data;

FIG. 7 is a schematic view for illustrating an operation to update the data range information;

FIG. 8 is a schematic view illustrating an example of output data output by a data output part;

FIG. 9 is a flowchart illustrating an example of the operations of the information search apparatus of the first exemplary embodiment;

FIG. 10 is a block diagram illustrating an example of the configuration of an information search apparatus according to a second exemplary embodiment;

FIG. 11 is a schematic view for illustrating the operation of an associated user data acquiring part; and

FIG. 12 is a flowchart illustrating an example of the operations of the information search apparatus of the second exemplary embodiment.

### DETAILED DESCRIPTION

### First Exemplary Embodiment

### Configuration of Information Search Apparatus

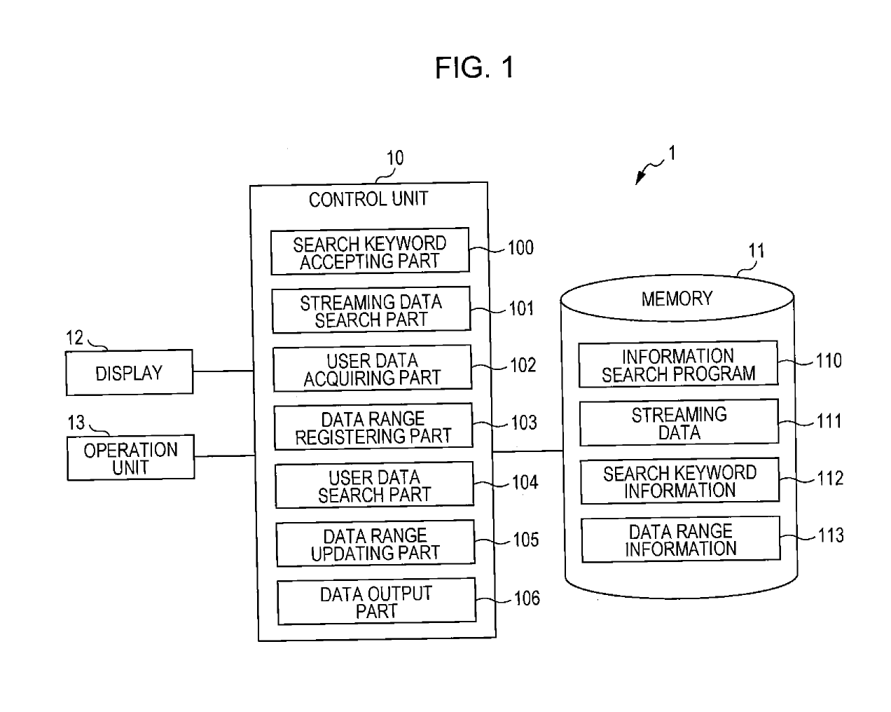

FIG. 1 is a block diagram illustrating an example of the configuration of an information search apparatus 1 according to a first exemplary embodiment of the invention.

Referring to FIG. 1, the information search apparatus 1 includes a control unit 10, a memory 11, a display 12 such as a liquid crystal display (LCD), and an operation unit 13. The control unit 10 is, for example, a central processing unit (CPU). The control unit 10 controls each component in the information search apparatus 1 and executes various programs. The memory 11 is a recording medium, such as a hard disk drive (HDD) or a flash memory, and is an example of a storage apparatus that stores information. The operation unit 13 includes a touch pad or multiple operation keys.

The control unit 10 executes an information search program 110 described below to function as, for example, a search keyword accepting part 100, a streaming data search part 101, a user data acquiring part 102, a data range registering part 103, a user data search part 104, a data range updating part 105, and a data output part 106.

The search keyword accepting part 100 accepts input of multiple search keywords in response to an operation by a user with the operation unit 13 to store the accepted search keywords in the memory 11 as search keyword information 112.

The streaming data search part 101 searches streaming data 111 described below for data including a keyword that is first input, among the search keywords accepted by the search keyword accepting part 100. The streaming data search part 101 does not necessarily search for the data including the keyword that is first input. For example, the streaming data search part 101 may search for data including the second, third, . . . keywords. The “streaming data” means data in which multiple pieces of character information (multiple posts) are managed in time series. In the exemplary embodiment, the character information also holds information about the user who has input the search keywords.

The user data acquiring part 102 acquires the character information (posts) within a certain time range with respect to the character information (post) including the search keyword used in the search by the streaming data search part 101, in the streaming data for the user who has input the character information (posts) including the search keyword, as user data.

At this time, the character information (posts) including the search keyword in a different time range for the same user, that is, the character information (posts) that is not included in the “certain time range” and that includes the search keyword is held as another piece of user data. For example, when a user has posted the character information including a search keyword in the evening on Aug. 25, 2012 and in the morning on Aug. 26, 2012, the posts within a certain time range with respect to the post in the evening on August 25 are held as one piece of user data and the posts within the certain time range with respect to the post in the morning on August 26 are held as another piece of user data.

The data range registering part 103 registers the user data acquired by the user data acquiring part 102 in data range information 113 described below as a data range.

The user data search part 104 searches the user data acquired by the user data acquiring part 102 for data including a keyword other than the keyword which the streaming data search part 101 has used for the search.

The data range updating part 105 updates the data range in the data range information 113 on the basis of the result of the search by the user data search part 104.

The data output part 106 outputs output data on the basis of the data range information 113 updated by the data range updating part 105.

The memory 11 stores, for example, the information search program 110, the streaming data 111, the search keyword information 112, and the data range information 113.

The information search program 110 is executed by the control unit 10 to cause the control unit 10 to function as the parts from the search keyword accepting part 100 to the data output part 106 described above.

The streaming data 111 is, for example, a microblog in which the character information is posted by multiple users. In the microblog, for example, multiple pieces of character information that are posted (transmitted) are displayed in time series. The unit of the character information posted in the microblog is hereinafter referred to as “posted information” for description. The posted information may include the character information and the Uniform Resource Locator (URL) of an external link, only the character information, or only the URL of the external link. In other words, microblog information includes multiple pieces of posted information.

The streaming data 111 may be data other than the microblog. It is sufficient for the streaming data 111 to be text information managed in time series. Other examples of the streaming data 111 will be described below. The streaming data 111 may be externally acquired.

The search keyword information 112 includes the multiple keywords accepted by the search keyword accepting part 100.

The data range information 113 is information that defines the time range of the posted information registered by the data range registering part 103 or the posted information updated by the data range updating part 105, among the posted information in the streaming data 111 managed in time series.

The information search apparatus 1 is, for example, a server apparatus or a personal computer. A mobile phone, a portable information processing terminal, etc. may be used as the information search apparatus 1.

### Operations of Information Search Apparatus

Operations of the present exemplary embodiment including (1) a search keyword accepting operation, (2) a streaming data search operation, (3) a user data acquiring operation, (4) a data range registering operation, (5) a user data search operation, (6) a data range updating operation, and (7) a data output operation will now be described.

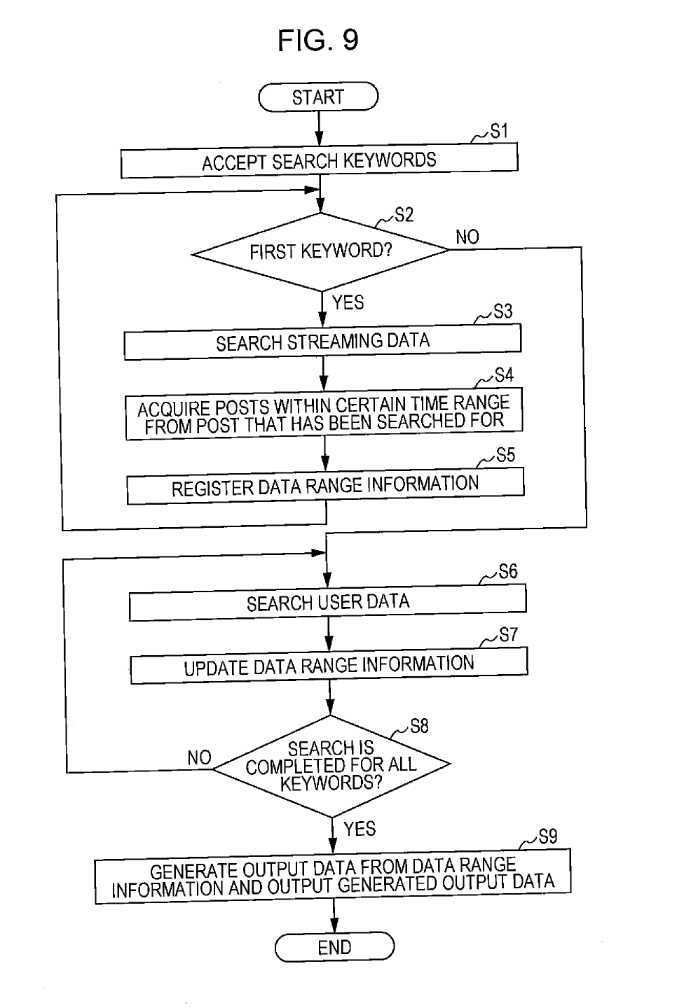

FIG. 9 is a flowchart illustrating an example of the operations of the information search apparatus 1.

### (1) Search Keyword Accepting Operation

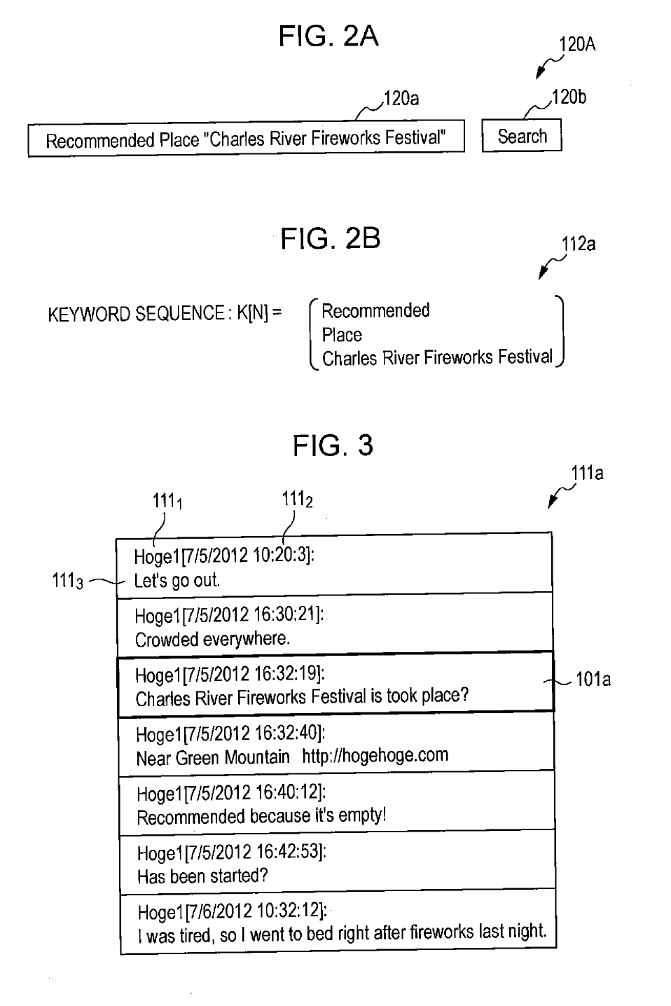

Referring to FIG. 9, in Step S1, the search keyword accepting part 100 accepts input of multiple search keywords in response to an operation by the user with the operation unit 13 in a search keyword input user interface 120A, as illustrated in FIG. 2A, to store the search keywords in the memory 11 as the search keyword information 112.

FIGS. 2A and 2B are schematic views illustrating an example of the search keyword input user interface that accepts input of the search keywords.

As illustrated in FIG. 2A, the search keyword input user interface 120A includes an input field 120a which is displayed in the display 12 and in which the user inputs the search keywords and a search button 120b for executing the search.

As illustrated in FIG. 2B, the keywords input in the input field 120a are stored as search keyword information 112a. The search keyword information 112a includes “Recommended”, “Place”, and “Charles River Fireworks Festival” in the example in FIG. 2B.

### (2) Streaming Data Search Operation

In Step S2, the streaming data search part 101 determines whether the search keyword accepted by the search keyword accepting part 100 is the first keyword. If the search keyword accepted by the search keyword accepting part 100 is the first keyword (Yes in Step S2), in Step S3, the streaming data search part 101 searches streaming data 111a for data including the keyword “Charles River Fireworks Festival” that is first input, among the search keywords accepted by the search keyword accepting part 100, as illustrated in FIG. 3. If the search keyword accepted by the search keyword accepting part 100 is not the first keyword (No in Step S2), the process goes to Step S6.

FIG. 3 is a schematic view illustrating an example of the structure of the streaming data.

As illustrated in FIG. 3, the streaming data 111a includes a user ID 111₁ for identifying the user who has posted the character information, a post time 111₂ indicating the time when the user has posted the character information, and content 111₃ indicating the content including the URL of another server (not illustrated) in which a sentence and/or an image (a still image or a movie) input as the posted information is stored or the sentence and the URL. The streaming data 111a may directly include information concerning the still image or the movie, instead of the URL in the content 111₃. Although the posts of only one user “Hoge1” are illustrated in FIG. 3, the posts of multiple users are actually arranged in time order.

The streaming data search part 101 acquires a post 101a including “Charles River Fireworks Festival” in the content 111₃ as the search result in the example illustrated in FIG. 3. The posts of a single user or multiple users are actually acquired as the search results.

The streaming data search part 101 may execute Step S3 on the basis of keyword “Recommended” or “Place other than the keyword that is first input. The streaming data search part 101 may adopt the keyword having the largest number of search results, among all the keywords.

### (3) User Data Acquiring Operation

In Step S4, the user data acquiring part 102 acquires the posts within a certain time range with respect to the post 101a including the search keyword “Charles River Fireworks Festival”, in the streaming data corresponding to the user “Hoge1” of the post 101a including the search keyword “Charles River Fireworks Festival” used in the search by the streaming data search part 101, as the user data. When one or more posts of multiple users are acquired as the search results in Step S3, Step S4 and the subsequent Steps S5 to S8 are executed for each piece of user data.

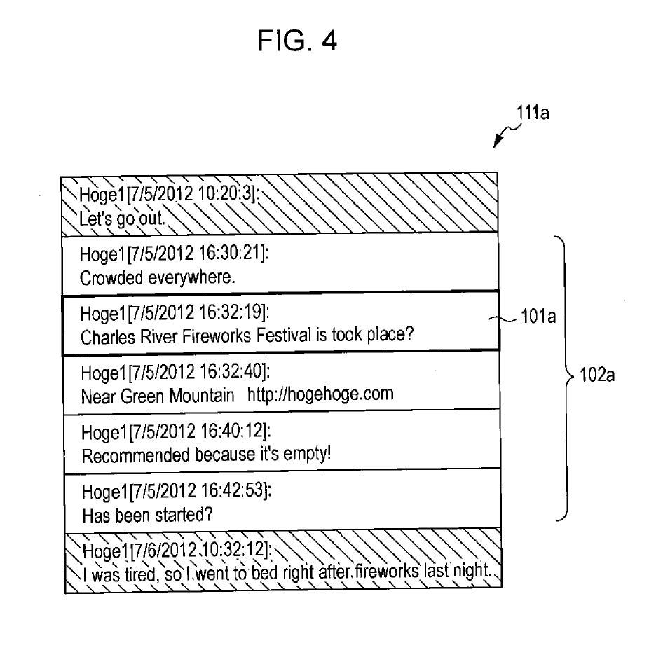

FIG. 4 is a schematic view illustrating an example of the structure of the user data.

As illustrated in FIG. 4, user data 102a includes the posts within a predetermined time range with respect to the post 101a including the “Charles River Fireworks Festival” in the streaming data 111a, for example, within three hours before and after the post 101a.

In the example in FIG. 4, the user data acquiring part 102 acquires the posts within a time range from a time 16:30:21 in Jul. 5, 2012 to a time 16:42:53 in Jul. 5, 2012, which are the posts within three hours before and after the time “16:32:19 in Jul. 5, 2012”, as the user data 102a.

The user data acquiring part 102 may acquire a predetermined number of posts before and after the post 101a. For example, the user data acquiring part 102 may acquire two posts before and after the post 101a. Alternatively, the user data acquiring part 102 may acquire continuous posts, that is, the posts the time interval of which from the post 101a is within a predetermined time. For example, the user data acquiring part 102 may acquire the next post if the time interval between the post 101a and the next post is within ten minutes, may acquire the subsequent two posts if the time interval between the next post and the second post beyond the post 101a is within ten minutes, and may not acquire the third post beyond the post 101a and the subsequent posts if the time interval between the second post beyond the post 101a and the third post beyond the post 101a is over ten minutes.

When the streaming data search part 101 has searched for multiple posts of the same user as the search results, the user data acquiring part 102 may acquire the range including all the multiple posts as the user data 102a.

### (4) Data Range Registering Operation

In Step S5, the data range registering part 103 registers the user data 102a acquired by the user data acquiring part 102 in the data range information 113.

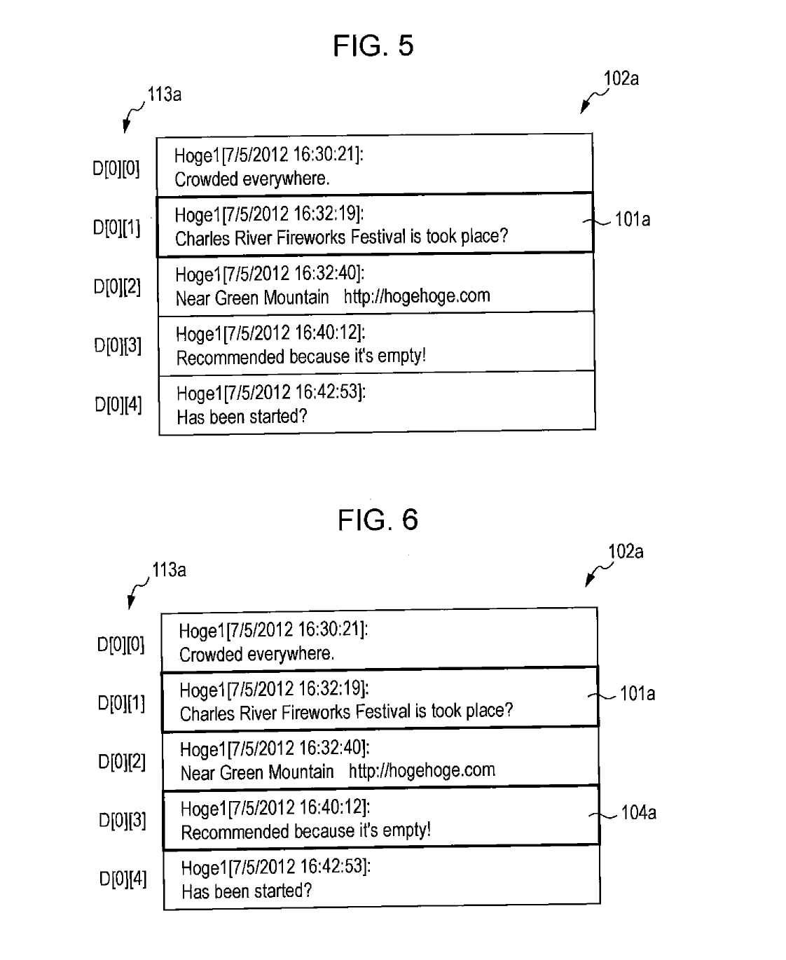

FIG. 5 is a schematic view illustrating an example of the relationship between the data range information and the user data.

As illustrated in FIG. 5, the user data 102a is registered as data range information 113a “D[0][0] to D[0][4]” by a display method using a user data sequence “D[j][V]” (j denotes a j-th user data and v denotes the number of each post included in the user data in time order).

### (5) User Data Search Operation

In Step S6, the user data search part 104 searches the user data 102a acquired by the user data acquiring part 102 for the posts including the second and subsequent keywords “Recommended” and “Place.”

FIG. 6 is a schematic view for illustrating a keyword search operation in the user data.

As illustrated in FIG. 6, the user data search part 104 searches the user data 102a and acquires a post 104a including the second keyword “Recommended” as the search result.

### (6) Data Range Updating Operation

In Step S7, the data range updating part 105 updates the data range of the data range information 113 on the basis of the post 104a, which is the result of the search by the user data search part 104.

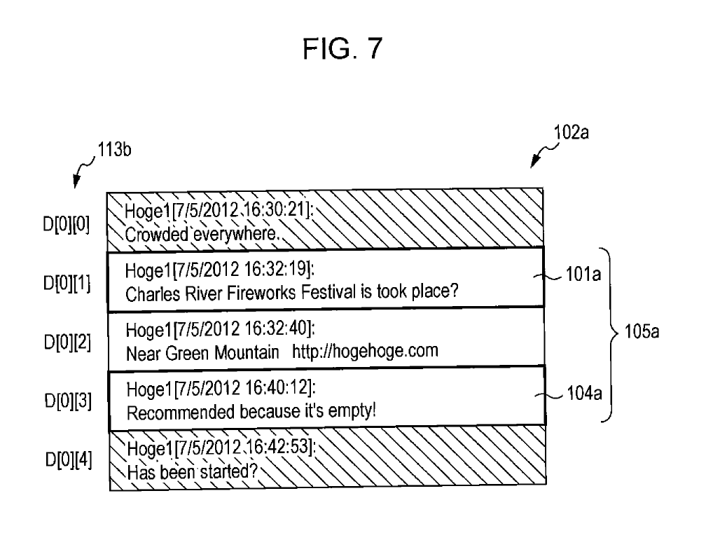

FIG. 7 is a schematic view for illustrating an operation to update the data range information.

As illustrated in FIG. 7, the data range updating part 105 updates the data range information 113 with data range information 113b “D[0][1] to D[0][3]” about data 105a included between the post 101a including “Charles River Fireworks Festival” and the post 104a including “Recommended.”

The data range updating operation is performed for all the second and subsequent keywords. Specifically, in Step S8, it is determined whether the search is completed for all keywords. If it is determined that the search is not completed for all keywords (No in Step S8), the process goes back to Step S6. If it is determined that the search is completed for all keywords (Yes in Step S8), the process goes to Step S9.

### (7) Data Output Operation

In Step S9, the data output part 106 outputs output data on the basis of the data range information 113 updated by the data range updating part 105.

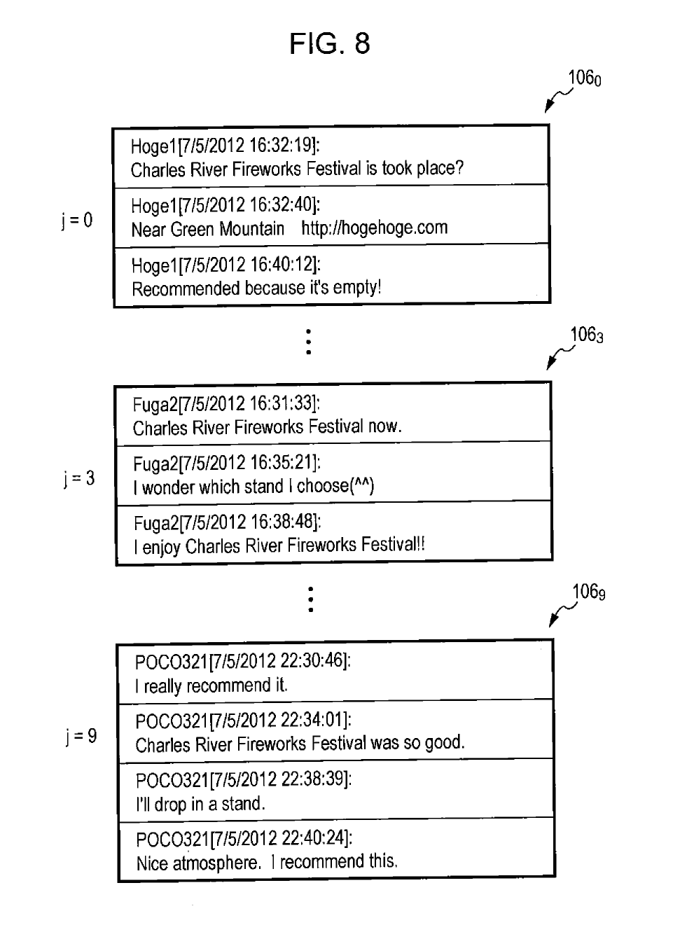

FIG. 8 is a schematic view illustrating an example of the output data output by the data output part 106.

Output data 106₀, output data 106₃, and output data 106₉ are the output data acquired for the zeroth user, the third user, and the ninth user, respectively.

### Advantages of First Exemplary Embodiment

According to the first exemplary embodiment described above, a series of posts of the user who has submitted the post searched for with the first keyword may be searched with any of the second and subsequent keywords and the range of the series of posts, which is the output data, may be determined on the basis of the search result. Accordingly, the posts that do not include the search word but are possibly related to the search word may be searched for from, for example, the streaming data 111 including multiple pieces of character information that are managed in time series and the posts that are searched for may be presented.

Specifically, as illustrated in FIG. 8, the output data 106₀ is information that is searched for with the search keywords “Charles River Fireworks Festival” and “Recommended”. Since the second post in the output data 106₀ includes a keyword “Green Mountain” that is not the search keyword but is possibly related to the search keyword, the user may acquire the information “Green Mountain” from the output data 106₀ and may acquire information other than the streaming data 111 from the URL described in the second post.

### Second Exemplary Embodiment

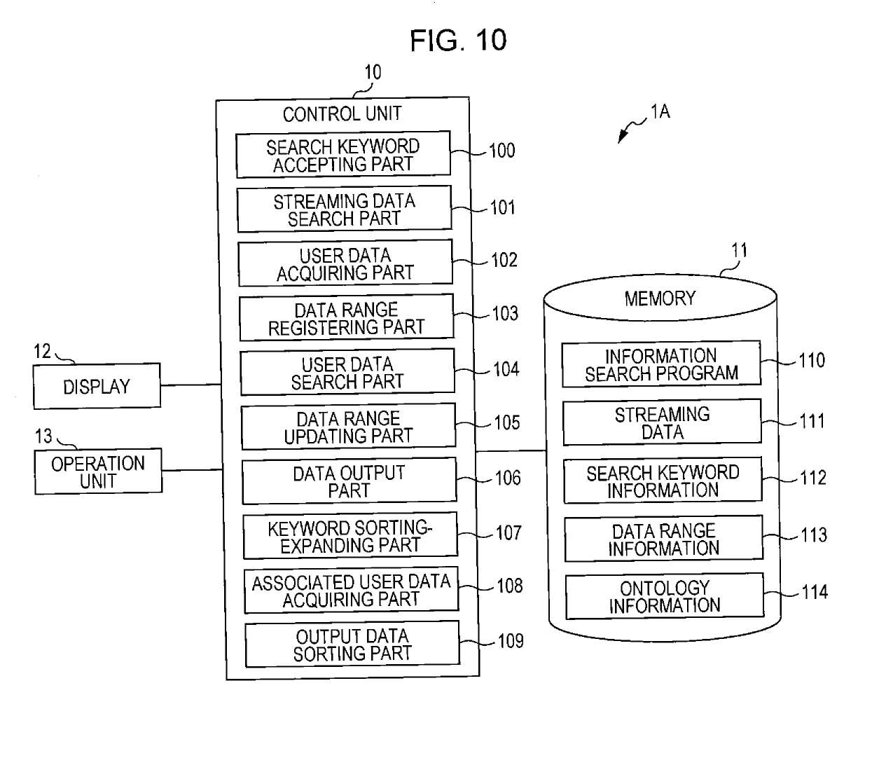

FIG. 10 is a block diagram illustrating an example of the configuration of an information search apparatus according to a second exemplary embodiment. The same reference numerals are used in the second exemplary embodiment to identify the same components in the first exemplary embodiment.

Referring to FIG. 10, an information search apparatus 1A further includes a keyword sorting-expanding part 107, an associated user data acquiring part 108, and an output data sorting part 109, in addition to the parts in the control unit 10 in the information search apparatus 1 of the first exemplary embodiment.

The keyword sorting-expanding part 107 sorts the multiple keywords accepted by the search keyword accepting part 100, for example, in descending order of Term Frequency-Inverse Document Frequency (TF-IDF), in descending order of the lengths of characters, in a manner in which priority is given to nouns, or in parsing order. The TF-IDF is a value calculated on the basis of two indexes: the term frequency and the inverse document frequency of a word. Words have higher TF-IDF values with the increasing term frequency and with the increasing rareness.

In addition, the keyword sorting-expanding part 107 expands each keyword accepted by the search keyword accepting part 100 into, for example, an equivalent term, a synonym, an antonym, a hypernym, a hyponym, an abbreviated form, or a multilingual form by phonological conversion by using ontology information 114 described below. For example, “Charles River Fireworks Festival” is expanded into “Ch Rv Fireworks Fes”, “CRFF” (abbreviated form), “Grand Feu d'artifice de Charles Rivière”, “Charlee River Fireworks Festival” (converted form), or “Grand Feu d'artifice de Charles River” (abbreviated-converted form).

The associated user data acquiring part 108 acquires the posts of another user, which are registered in an arbitrary list managed by the user about whom the user data is acquired, and adds the acquired posts to the user data. The “other user registered in an arbitrary list managed by the user” is, for example, a user called a “follower” or a user registered in a “list” in Twitter or a user called a “friend” in Facebook (registered trademark).

The output data sorting part 109 sorts the pieces of output data output by the data output part 106, for example, in order of the post times of the posts included in the output data, in a manner in which priority is given to the output data including a post including an URL, or in order of similarity to the search keyword and outputs the sorted pieces of output data. The degree of similarity between the search keyword and the output data is calculated, for example, in a manner in which each piece of output data is considered as a document, the document is subjected to morphological analysis to create word vectors, and the degree of similarity is calculated on the basis of cosine similarity between the word vectors.

The information search apparatus 1A further includes the ontology information 114, in addition to the parts in the memory 11 in the information search apparatus 1 of the first exemplary embodiment. The ontology information 114 may be externally acquired.

The ontology information 114 is used in the keyword sorting-expanding part 107. The ontology information 114 is a dictionary to expand the keyword into, for example, an equivalent term, a synonym, an antonym, a hypernym, a hyponym, an abbreviated form, or a multilingual form by phonological conversion.

### Operations in Second Exemplary Embodiment

Since the operations in the second exemplary embodiment are the same as those in the first exemplary embodiment except the following operations, a description of the operations that are the same as those in the first exemplary embodiment is omitted herein.

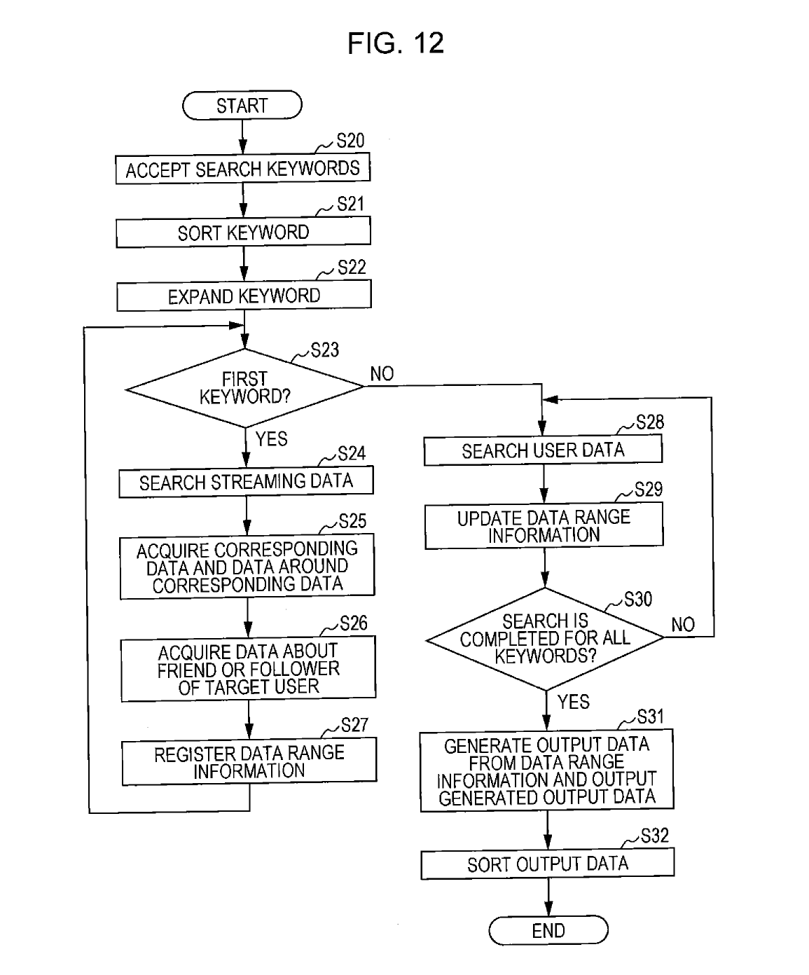

FIG. 12 is a flowchart illustrating an example of the operations of the information search apparatus 1A.

Referring to FIG. 12, in Step S21, the keyword sorting-expanding part 107 sorts the multiple keywords accepted by the search keyword accepting part 100, for example, in descending order of the TF-IDF, in descending order of the lengths of characters, in the manner in which priority is given to nouns, or in parsing order.

In Step S22, the keyword sorting-expanding part 107 expands each keyword accepted by the search keyword accepting part 100 by using the ontology information 114. The expanded keywords are used by the streaming data search part 101 and the user data search part 104.

In Step S26, the associated user data acquiring part 108 acquires the posts of another user, which are registered in an arbitrary list managed by the user about whom the user data is acquired, and adds the acquired posts to the user data.

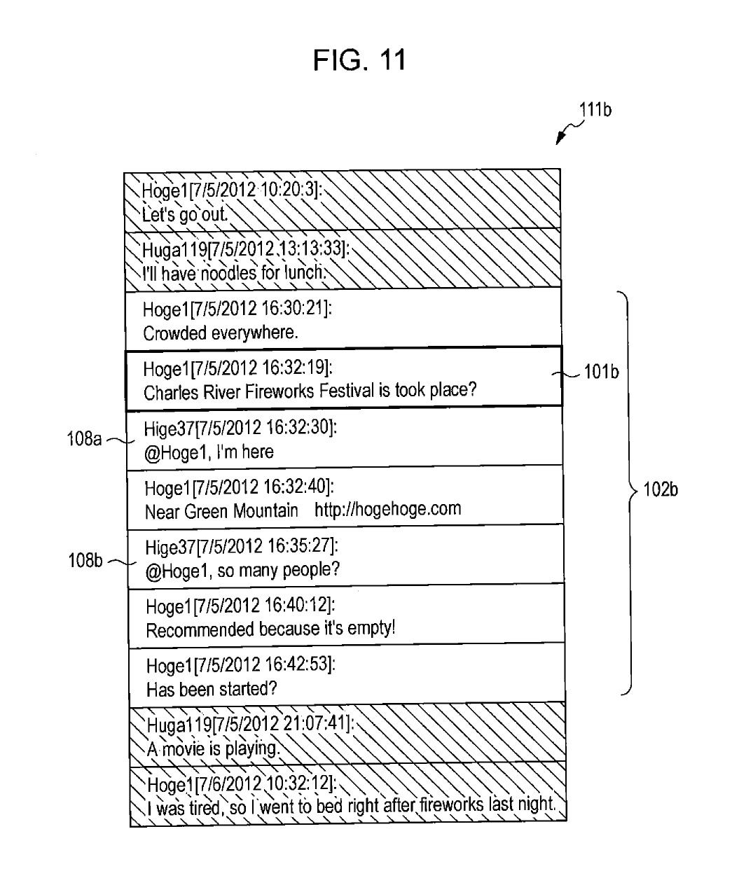

FIG. 11 is a schematic view for illustrating the operation of the associated user data acquiring part 108.

When a post 101b the user ID 111₁ of which is “Hoge1” is searched for as the result of the search by the streaming data search part 101 and a user “Hige37” is registered as a user associated with the user “Hoge1” in streaming data 111b, the associated user data acquiring part 108 acquires posts 108a and 108b of the user “Hige1” within three hours before and after the post 101b and adds the posts 108a and 108b to the posts acquired by the user data acquiring part 102 to generate user data 102b.

In Step S32, the output data sorting part 109 sorts the pieces of output data output by the data output part 106, for example, in order of the post dates of the posts included in the output data, in a manner in which priority is given to the output data including a post including an URL, or in order of similarity to the search keyword and outputs the sorted pieces of output data.

### Advantages of Second Exemplary Embodiment

According to the second exemplary embodiment described above, since the posts 108a and 108b acquired by the associated user data acquiring part 108 are added to the user data, the posts that do not include the search word but are possibly related to the search word may be searched for also from the posts of another associated user, among the multiple posts including the character information and the time-series information in the streaming data 111b or the like, and the posts that are searched for may be presented.

Soring the multiple search keywords to change the first keyword on the basis of a predetermined condition allows the posts of a user meeting the condition to be searched for. Expanding the search keywords allows a larger number of search results to be acquired.

Since the output data sorting part 109 updates the output data on the basis of a predetermined condition, the output data may be displayed in order of coincidence with the condition. For example, the output data including a post including an URL from which information other than the streaming data 111 is capable of being acquired may be displayed by priority to present a larger amount of information to the user.

### Other Exemplary Embodiments

While the invention is described in terms of some specific exemplary embodiments, it will be clear that this invention is not limited to these specific exemplary embodiments and that many changes and modified embodiments will be obvious to those skilled in the art without departing from the true spirit and scope of the invention. For example, the microblog is not limited to Twitter and messages of any kind, such as Facebook (registered trademark), are applicable to the invention as long as relatively short sentences are included and as long as a large amount of mixture of the character information with image information (including a still image, a movie, and information indicating the destination of link of the information) is displayed in time series. The invention is applicable to, for example, messages of electronic mails.

For example, the search to which the invention is applied may be performed for, for example, a movie in which multiple persons appear and they have a conversation with each other. Specifically, sounds in the movie or the like may be subjected to sound analysis to make texts of the sounds for every person in time series and the search with a search keyword may be performed to the texts. As a result, the range of the texts including the keyword as the search result is output as the output data. In other words, in the above case, scenes within a certain range of the movie are extracted from the range of the texts and the scenes include sounds and/or images that do not include the keyword but are highly related to the keyword.

Alternatively, image analysis (for example, using an optical character reader (OCR)) is performed from an arbitrary frame in a movie to make texts of characters included in a whiteboard or presentation slides and the search with a search keyword may be performed to the texts. As a result, the range of the texts including the keyword as the search result is output as the output data. In other words, in the above case, scenes within a certain range of the movie are extracted from the range of the texts and the scenes include sounds and/or images that do not include the keyword but are highly related to the keyword.

Although the functions of the parts from the search keyword accepting part 100 to the output data sorting part 109 in the control unit 10 are realized by the programs in the above exemplary embodiments, part or all of the parts may be realized by hardware, such as Application Specific Integrated Circuits (ASICs). Alternatively, the programs used in the above exemplary embodiments may be stored in a recording medium, such as a compact disk-read only memory (CD-ROM), and the recording medium may be supplied. The orders of the steps described in the above exemplary embodiments may be changed or the steps described in the above exemplary embodiments may be deleted or added without departing from the true spirit and scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process comprising:
accepting input of a plurality of search keywords;
searching streaming data in which a plurality of pieces of character information about a plurality of users are managed in time series for the character information including one of the plurality of search keywords that are accepted;
acquiring the character information within a predetermined time range with respect to the character information including the one of the plurality of search keywords, among the other pieces of character information about the user who has posted the character information that is searched for and that includes the one of the plurality of search keywords, as user data;
searching the acquired user data for the character information including the plurality of search keywords other than the one search keyword; and
outputting the character information within a predetermined time range with respect to the result of the search in the user data as output data.

2. The non-transitory computer readable medium according to claim 1,
wherein the acquiring also acquires the character information within the predetermined time range about another user associated in advance with the user who has posted the character information including the one of the plurality of search keywords, in the acquisition of the character information within the predetermined time range with respect to the character information including the one of the plurality of search keywords.

3. The non-transitory computer readable medium according to claim 1,
wherein, when a plurality of pieces of output data exists, the outputting sorts the plurality of pieces of output data in a manner in which priority is given to the pieces of output data whose character information includes information for referring to information other than the character information and outputs the plurality of pieces of output data that is sorted.

4. The non-transitory computer readable medium according to claim 2,
wherein, when a plurality of pieces of output data exists, the outputting sorts the plurality of pieces of output data in a manner in which priority is given to the pieces of output data whose character information includes information for referring to information other than the character information and outputs the plurality of pieces of output data that is sorted.

5. An information search apparatus comprising:
an accepting unit that accepts input of a plurality of search keywords;
a first search unit that searches streaming data in which a plurality of pieces of character information about a plurality of users are managed in time series for the character information including one of the plurality of search keywords accepted by the accepting unit;
an acquiring unit that acquires the character information within a predetermined time range with respect to the character information including the one of the plurality of search keywords, among the other pieces of character information about the user who has posted the character information that is searched for by the first search unit and that includes the one of the plurality of search keywords, as user data;
a second search unit that searches the user data acquired by the acquiring unit for the character information including the plurality of search keywords other than the one search keyword; and
an output unit that outputs the character information within a predetermined time range with respect to the result of the search by the second search unit in the user data as output data.

6. An information search method comprising:
accepting input of a plurality of search keywords;
searching streaming data in which a plurality of pieces of character information about a plurality of users are managed in time series for the character information including one of the plurality of search keywords that are accepted;
acquiring the character information within a predetermined time range with respect to the character information including the one of the plurality of search keywords, among the other pieces of character information about the user who has posted the character information that is searched for and that includes the one of the plurality of search keywords, as user data;
searching the acquired user data for the character information including the plurality of search keywords other than the one search keyword; and
outputting the character information within a predetermined time range with respect to the result of the search in the user data as output data.
